(19) United States
(12) Patent Application Publication
(10) Pub. No.: US 2004/0215968 A1
(43) Pub. Date: Oct. 28, 2004

(54) Determining identity data for a user

(76) Inventors: Philip M. Rodwell, Cornwall (GB); Paul Reynolds, Bristol (GB)

Correspondence Address: Christopher M Tobin, Collier Shannon Scott, Suite 400, 3050 K Street NW, Washington, DC, 20007, US

(21) Appl. No.: 10/476,588

(22) PCT Filed: May 3, 2002
(86) PCT No.: PCT/GB02/02074

(30) Foreign Application Priority Data
May 3, 2001 (GB) 0110931.3

(51) Int. Cl. H04K 1/00

(52) U.S. Cl. 713/186

(57) ABSTRACT

According to the present invention there is provided a method of determining identity data in respect of a user of an electronic device, the method comprising the steps of: the electronic device receiving a second sound signal resulting from a first sound signal interacting with a part of the head of the user; deriving a signature from at least the second sound signal, the signature being characteristic of a topography of a part of the head of the user, determining identity data in dependence on the signature. In one embodiment, the electronic device produces the first sound signal which is substantially undetectable by the human ear or unobtrusive to the user. In another embodiment, the first sound signal is produced by the user.

### FIELD OF THE PRESENT INVENTION

The present invention relates to determining identity data for a user of an electronic device using a biometric technique. More particularly, but not exclusively, the present invention relates to using a biometric technique for authentication of a user of a telephony device.

### BACKGROUND OF THE PRESENT INVENTION

Historically, there has been a general need for user authentication in the fields of electronics, data processing, computer networks and telecommunications. For example, the user of an automated telling machine (ATM) will normally be required to enter a personal identification number (PIN) before being allowed access to bank account services or funds. Similarly, for user access to private or public computer networks, such as an intranet or the Internet, typically the user will need to enter a user name and password before being allowed access. Internet Service Providers (ISPs) typically implement authentication, authorisation and accounting (AAA) systems to a) ascertain who the user is (authentication), b) determine access rights for the user (authorisation), and c) set up the necessary charging mechanisms for the user (accounting). The processes of authorisation and accounting are both dependent on successful authentication. Similarly, individual network resources such as Web sites, and other services, may also implement conditional access systems using, for example, user name and password entry.

In the field of mobile communications, in particular with second generation systems such as the Global System for Mobile communications (GSM), security is implemented through data encryption and subscriber authentication via use of a smart card known as the Subscriber Identity Module (SIM). The mobile station may optionally be set to require entry of a PIN before allowing access to the data stored on the SIM and non-emergency calls.

However, the technique of requiring a PIN is not truly personal to the subscriber and is based on transferable knowledge—i.e. the PIN code. Thus, the technique is vulnerable to masquerade attacks whereby a third party obtains or successfully guesses the PIN number and is able to masquerade as the subscriber. The same can be said of any technique requiring a password, such as the user name and password technique.

Furthermore, PIN or user name and password techniques are point of entry techniques, which only perform authentication periodically on the occurrence of certain events, such as on switching on a mobile station. Thus, an unauthorised party obtaining a previously authenticated mobile station may not be required to undergo further authentication until the mobile station is switched off or runs out of power. This problem is exacerbated with improvements in power capacity of mobile stations whereby mobile stations need hardly ever be switched off.

Furthermore, the problems of point of entry authentication techniques, such as requiring a PIN code or a user name and password, are becoming exacerbated with the advent of “always on” telecommunications access whereby a user of a fixed or mobile telecommunications device is provided with continuous access to network resources and services without having to periodically dial up a connection and undergo point of entry authentication.

With the advent of third generation mobile communications technologies, and with the convergence of fixed and mobile telecommunications and computer networks, more services of greater value will be accessible via both mobile and fixed stations. More advanced and potentially more sensitive information, such as bank account information, geographic location, private correspondence and so on, will be accessible from a multitude of telecommunications devices. For example, e-mail, e-commerce transactions, and location-based services may be available to users of both mobile and fixed telecommunications devices.

Thus, it can be seen that there will be an increasing need for greater security in future mobile and fixed telecommunications systems and, in particular, a need for enhanced, truly personal, and continuous, user-based authentication.

International publication no. WO 99/08238 discloses a portable client personal digital assistant (PDA) with a microphone and local central processing unit (CPU) capable of processing biometric data to provide user verification. The device includes a modem to provide direct communications with peripheral devices and is capable of transmitting or receiving information through wireless communication. Optionally, a biometric sensor may be provided for collecting biometric data such as a finger, thumb or palm print, a handwriting sample, a retinal vascular pattern, or a combination thereof, to provide biometric verification. However, the document discloses a preference for biometric verification through voice data.

International publication no. WO 99/45690 discloses a protected access system for controlling access to networks such as telephone networks, which may use biometric characteristics for subscriber identification. The document discloses using any of three biometric characteristics for authentication, namely, retina patterns, speech or voice characteristics of fingerprints.

International publication no. WO 99/54851 discloses a device, such as a mobile telephone and SIM card, comprising sensors for detecting biometric characteristics and a data processing device for determining authentication information from the biometric characteristics. The document discloses using any of three biometric characteristics, namely, fingerprints, retinal patterns, and voice or speech characteristics.

U.S. Pat. No. 5,872,834 discloses a telephone provided with a contact imaging device for obtaining biometric data to identify or authenticate the user. Contact imaging devices are stated to include electrical contact imaging sensors such as capacitative fingerprint imagers and optical contact imaging sensors such as optical fingerprint imagers. The user must make physical contact with an electrical or optical component of the imager for biometric data to be obtainable.

The CAVE project (CAller VErification in banking and telecommunications) and the follow up project PICASSO (PIoneering Caller Authentication for Secure Service Operation) are known research projects in the field of speaker verification in which authentication of a user of a telephony service is based upon an analysis of their voice characteristics. Both research projects focussed on text-dependent speaker verification, in the sense that the verification procedure assumes that the text of the spoken utterance is known by the verification system. This results in more accurate verification, but requires the user to utter known words or phrases before authentication may take place.

One problem with voice or speaker verification techniques is that for accuracy, the subject must utter predetermined words or phrases, which may not be possible in many cases and may become inconvenient and tiresome for the subject. Furthermore, if text dependent techniques are used, continuous verification is not possible. In any case, whether text dependent or independent techniques are used, the subject is required to be speaking before an authentication judgement can be made. These and other problems are solved by the present invention.

U.S. Pat. No. 5,787,187 discloses systems and methods for biometric identification using the acoustic properties of the ear canal. The document describes emitting an acoustic source signal into the ear of an individual and receiving a response signal using an apparatus, which for the sake of user-friendliness, resembles a telephone handset but which has no telephonic capability. The source signal described is humanly audible being, in one embodiment, a series of frequency tones ranging from 1 kHz to 20 kHz in 100 Hz increments each of about 100 cycles duration, and, in another embodiment, broad-band noise. Ear canal feature data is obtained and stored in an enrolment procedure and may be used to identify an individual on subsequent access attempts. The document describes applications of the system in the field of access control to information or property. The document describes only a “point of entry” type approach to identification—ie an individual is only identified prior to being granted access to information or property.

British Patent no. 1,450,741 describes a method and apparatus for biometric identification involving the application of sonic energy to a person's body, for example to a person's arm. As with U.S. Pat. No. 5,787,187, the applied sonic signal is humanly audible being generated, in a preferred embodiment, by a sweep frequency generator sweeping from 100 Hz to 10 kHz repeatedly. Again, as with U.S. Pat. No. 5,787,187, the document describes only a “point of entry” type approach to identification—ie an individual is only identified prior to being granted access to secure data or property.

One problem with the “point of entry” approach of both U.S. Pat. No. 5,787,187 and British Patent no. 1,450,741 is that it does not provide a continuous authentication scheme suited to the provision of continuous services, such as telecommunications services, in which the “point of entry” may occur infrequently or not at all, once a one-off initial authentication has been performed. As described above, in the field of telecommunications services the problem is exacerbated with the advent of “always on” telecommunications access whereby a user of a fixed or mobile telecommunications device is provided with continuous access to network resources and services without having periodically to dial up a connection and undergo point of entry authentication. In the field of mobile telecommunications, improvements in power capacity of mobile stations whereby mobile stations need hardly ever be switched off also exacerbates the problem, as discussed above.

### SUMMARY OF THE PRESENT INVENTION

According to a first aspect of the present invention there is provided a method of determining identity data in respect of a user of an electronic device, the method comprising the steps of:

a) the electronic device producing a first sound signal which is substantially undetectable by the human auditory apparatus;

b) the electronic device receiving a second sound signal resulting from the first sound signal interacting with a part of the body of the user;

c) deriving a signature from at least the second sound signal, the signature being characteristic of a topography of a part of the body of the user; and

d) determining identity data in dependence on the signature.

Being substantially undetectable by the human auditory apparatus, the first sound signal may be produced continuously or during use of the electronic device for its intended purpose without interfering with the functioning of the device or disrupting the user experience. For example, the first sound signal may be produced during the provision of a telecommunications service via the electronic device. Thus authentication may be performed continuously or during use of the electronic device enabling enhanced security over known “point of entry” authentication techniques.

According to a second aspect of the present invention there is provided a method of determining identity data in respect of a user of an electronic device, the method comprising the steps of:

a) the electronic device receiving a second sound signal resulting from a first sound signal, produced by the user, interacting with a part of the body of the user;

b) deriving a signature from at least the second sound signal, the signature being characteristic of a topography of a part of the body of the user;

c) determining identity data in dependence on the signature.

By using a first sound signal produced by the user, such as the speech, mumblings or even breathing of the user, authentication may be performed continuously or during use of the electronic device for its intended purpose without interfering with the functioning of the device or disrupting the user experience. Thus enhanced security over known “point of entry” authentication techniques is enabled.

According to a third aspect of the present invention there is provided a telephony device comprising a locally accessible data store, the data store storing data representing one or more sound signals, the telephony device being controllable by a remote device to produce a first sound signal using data stored in the data store and to receive a second sound signal resulting from the first sound signal interacting with a part of the body of a user for use in determining identity data in respect of the user. Thus, the quality of original sound signal generated may be guaranteed and network traffic reduced.

According to a fourth aspect of the present invention there is provided a telephony device comprising a loudspeaker for generating a first sound signal and a microphone for receiving a second sound signal resulting from the first sound signal having interacted with a part of the head of a user of the telephony device, the telephony device being arranged so that, when in normal operation by a user, the loudspeaker and microphone are located adjacent to an ear of the user.

According to a fifth aspect of the present invention there is provided an earpiece or headpiece for use with a telephony device, the earpiece or headpiece comprising a loudspeaker for generating a first sound signal and a microphone for receiving a second sound signal resulting from the first sound signal having interacted with a part of the head of a user of the telephony device, the earpiece or headpiece being arranged so that, when in normal operation by a user, the loudspeaker and microphone are located adjacent to an ear of the user.

Further aspects of the invention are as set out in the appended claims.

There now follows, by way of example only, a detailed description of preferred embodiments of the present invention in which:

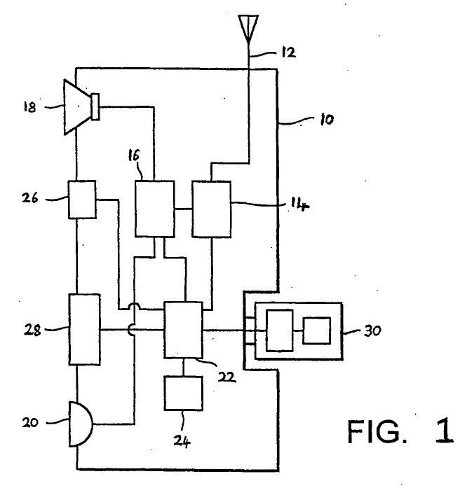

FIG. 1 is a schematic diagram of a known mobile station of a mobile telecommunications network for use in the present invention;

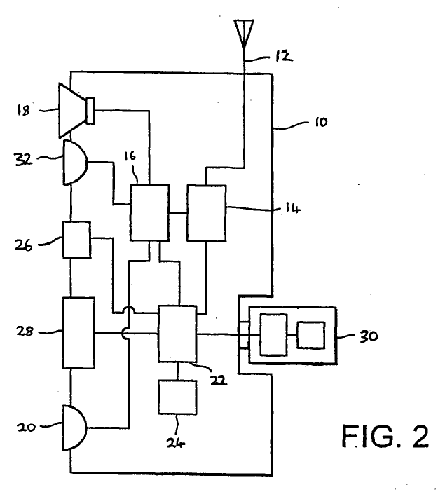

FIG. 2 is schematic diagram of an adapted mobile station for use in the present invention;

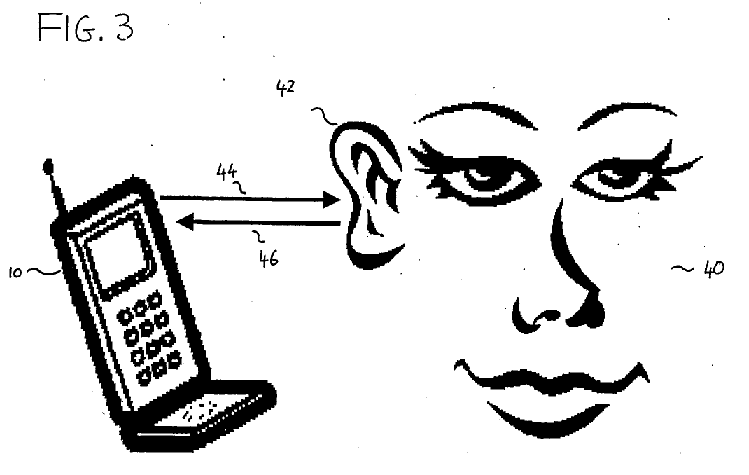

FIG. 3 is a schematic diagram showing the process of determining identity data for a user in a first mode where the mobile station generates the original sound;

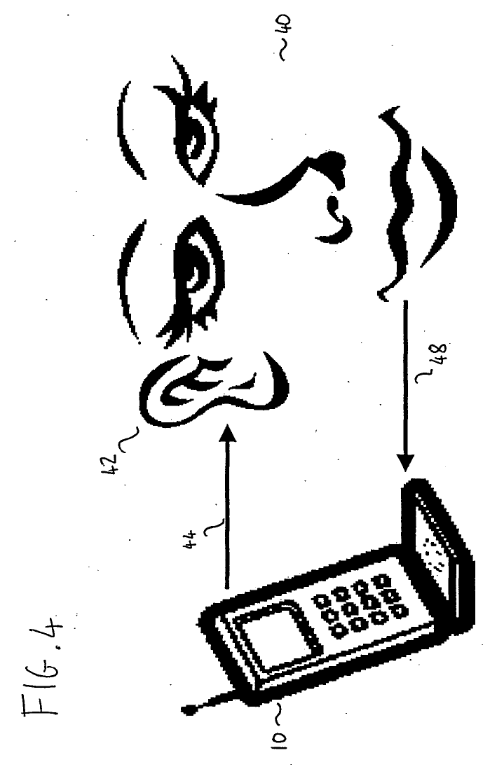

FIG. 4 is a schematic diagram showing the process of determining identity data for a user in a second mode where the mobile station generates the original sound;

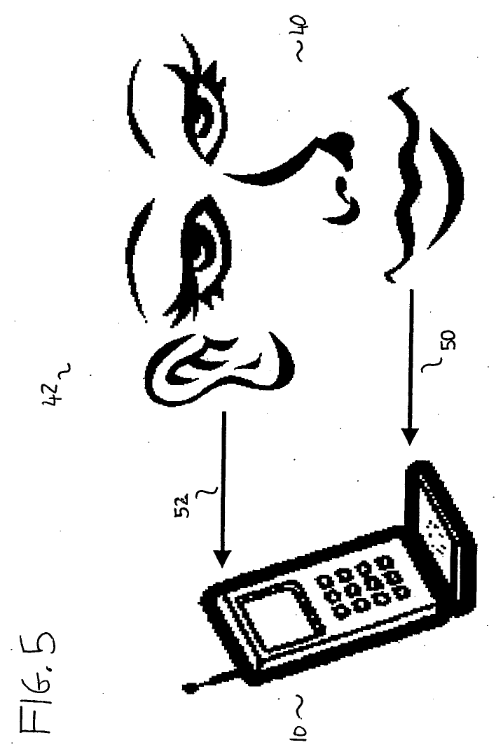

FIG. 5 is a schematic diagram showing the process of determining identity data for a user in a third mode where the user generates the original sound; and

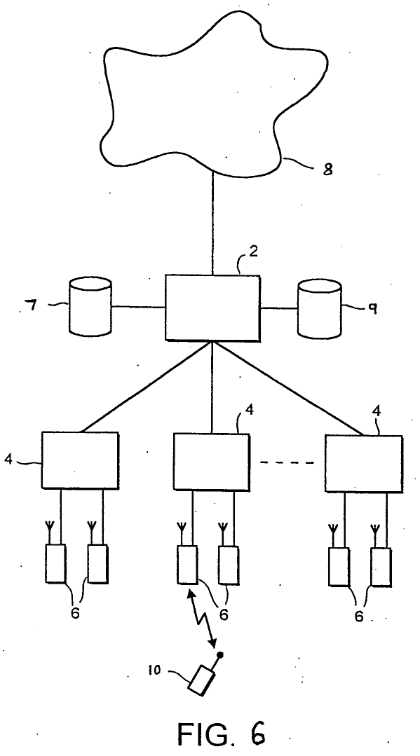

FIG. 6 is a schematic diagram showing a mobile telecommunications network in which the present invention may be performed.

### DETAILED DESCRIPTION OF PREFERRED EMBODIMENTS OF THE PRESENT INVENTION

A known second generation mobile telecommunications network, such as a GSM network, is schematically illustrated in FIG. 6. This is in itself known and will not be described in detail. A mobile switching centre (MSC) 2 is connected via communication links to a number of base station controller (BSCs) 4. The BSCs 4 are dispersed geographically across areas served by the mobile switching centre 2. Each BSC controls one or more base transceiver stations (BTSs) 6 located remote from, and connected by further communication links to, the BSC. Each BTS 6 transmits radio signals to, and receives radio signals from, mobile stations 10 which are in an area served by that BTS. That area is referred to as a “cell”. A mobile network is provided with a large number of such cells, which are ideally contiguous to provide continuous coverage over the whole network territory.

A mobile switching centre 2 is also connected via communications links to other mobile switching centres in the remainder of the mobile communications network 8, and to other networks such as a public service telephone network (PSTN), which is not illustrated. The mobile switching centre 2 is provided with a home location register (HLR) 7 which is a database storing subscriber authentication data including the international mobile subscriber identity (IMSI) which is unique to each mobile station 8. The IMSI is also stored in the mobile station in a subscriber identity module (SIM) along with other subscriber-specific information. The mobile switching centre is also provided with a visitor location register (VLR) 9 which is a database temporarily storing subscriber authentication data for mobile stations active in its area.

FIG. 1 is a schematic diagram of a known mobile station for use with the mobile telecommunications network according to the present invention. The mobile station 10 comprises a transmit/receive aerial 12, a radio frequency transceiver 14, a speech coder/decoder 16 connected to a loudspeaker 18 and a microphone 20, a processor circuit 22 and its associated memory 24, an LCD display 26 and a manual input port (keypad) 28, and a removable SIM 30. The loudspeaker 18 and microphone 20 are both connected to the processor circuit 22 via speech coder/decoder 16. Speech coder/decoder 16 comprises an analogue to digital converter (ADC) connected to microphone 20 and a digital to analogue converter (DAC) connected to loudspeaker 18. Mobile station 10 may communicate with BTSs 6 of the mobile telecommunications network using radio signals transmitted by transmit/receive aerial 12.

Typically, coder/decoder 16 uses a digital coding format optimised for efficient transmission of data representing voice or speech over low bandwidth communications channels. In particular, the coding formats used generally do not substantially represent sound at frequencies outside the human auditory range. Thus, in embodiments of the present invention using standard, unadapted mobile stations for second generation mobile networks, the process of determining identity data is preferably performed using in-band (i.e. within the human auditory frequency range) sound signals. Alternatively, in embodiments of the present invention using out-of-band sound signals, in particular ultra-sonic signals, an adapted mobile station may be used in which coder/decoder 16 is arranged to use a different data coding format, when being used for the purposes of determining identity data, the different data coding format being suited to represent the sound signals at the frequencies used.

FIG. 2 is schematic diagram of an adapted mobile station for use with the mobile telecommunication network according to the present invention. The mobile station 10 of FIG. 2 is as described with reference to FIG. 1, save that an additional microphone 32 is located at the earpiece close to loudspeaker 18 and also connected to speech coder/decoder 16. A further ADC may also be provided in coder/decoder 16 connected to microphone 32 for separately converting the analogue signals received from microphone 32. Again, for embodiments of the present invention using out-of-band sound signals, coder/decoder 16 may be arranged, when being used for the purposes of determining identity data, to use a data coding format suited to represent the sound signals at the frequencies used. According to a further embodiment of the present invention, the functions of loudspeaker 18 and microphone 32 are both performed by a single sound transceiver located at the earpiece of mobile station 10.

Although FIGS. 1 and 2 show mobile stations using inbuilt loudspeakers and microphones, “hands-free” equipment consisting of a loudspeaker and/or microphone separate from but connectable to the mobile station, may also be used in the present invention. Furthermore, an adapted hands-free earpiece or headpiece comprising a loudspeaker and microphone corresponding to loudspeaker 18 and microphone 32 of FIG. 2 may also be used when connected to an adapted mobile station such as shown in FIG. 2. Alternatively, the loudspeaker and microphone of the adapted earpiece or headpiece may be combined into a single sound transceiver as described above.

The process of determining identity data for a user of mobile station 10 may be controlled by either processor 22, the processor of SIM 30, or by one or more nodes of the mobile telecommunications network, such as any of BTSs 6, BSCs 4, MSC 2 or any other node of the remainder of the network 8. We shall refer to the entity controlling the process of determining identity data as the authenticating entity. In embodiments of the present invention in which original sound signals are generated by loudspeaker 18 of mobile station 10, digital data representing an original sound signal, formatted in a suitable data coding format, is sent by the authenticating entity to coder/decoder 16 for decoding and causing the generation of the original sound signal at loudspeaker 18. Conversely, interacted sound signals received by microphones 20 or 32 are coded into digital data by coder/decoder 16 and are sent to the authenticating entity. Where the authenticating entity is the processor of SIM 30, the data is sent over the mobile station/SIM interface. Where the authenticating entity is a node of the mobile telecommunications network, the data is sent over the radio interface via radio frequency transceiver 14 and transmit/receive aerial 12. Preferably, where the authenticating entity is a node of the mobile telecommunications network, data sent between the authenticating entity and the mobile station/SIM is encrypted.

In embodiments of the present invention in which original sound signals are generated by loudspeaker 18 of mobile station 10, a plurality of different original sound signals may be used. The authenticating entity may generate the data representing the original sound signal to be used, or select from one or more pre-generated data items stored in a data store accessible to it. For example, where processor 22 is the authenticating entity, pre-generated data may be stored in memory 24. Where the processor of SIM 30 is the authenticating entity, pre-generated data may be stored in a memory of the SIM card. Alternatively, the authenticating entity may control the generation of the data representing the original sound signal by another device, or control another device to select from one or more pre-generated data items stored in a data store accessible to the other device. For example, where the authenticating entity is a node of the network, the node may choose a pre-determined original sound signal to be used and control processor 22, or the processor of SIM 30, to generate or select pre-generated data representing the chosen signal.

FIG. 3 is a schematic diagram showing the process of determining identity data for a user in a first mode where mobile station 10 generates the original sound signal. Mobile station 10 is an adapted mobile station as described with reference to FIG. 2. When in normal operation, a user holds mobile station 10 to his or her head 40 so that the loudspeaker 18 and microphone 32 of the earpiece are adjacent an ear 42 of the user. When authentication is required by the authenticating entity, coder/decoder 16 is controlled to cause loudspeaker 10 to generate an original sound signal 44. Preferably, the generated sound signal is pink noise (i.e. band-limited white noise) within the human auditory range (approximately 20-20,000 Hz), so that the standard data coding format of coder/decoder 16 may be used. However, the signal is of short enough duration so as to be undetectable or at least non-intrusive to the user. A duration of 10 ms or less is sufficiently short to be undetectable or at least non-intrusive to the user. In an alternative embodiment, out-of-band (i.e. outside the human auditory range) sound frequencies may be used, in particular ultra-sonic frequencies which enable a higher physical resolution than lower frequency signals. Ultra-sonic frequencies would be undetectable to the user thus resulting in completely transparent authentication. In this case, coder/decoder 16 is arranged to use a data coding format suited to the frequency range of the signals 44 and 46 as described above.

Additionally, the original sound signal 44 may have a predetermined signature. For example, a pink noise signal may be adapted by varying the amplitudes of the signal at selected frequencies. By selecting from a plurality of original sound signals with different signatures, further security is added to the system in that an attacker is presented with a varying “challenge”. The sound signal 44 of predetermined signature is preferably selected by the authentication entity. Selection may be on a random or pseudo-random basis, or in dependence on a) an identity or characteristic of an authorised subscriber of the mobile network, b) an identity or characteristic of an authorised user of services accessible via the mobile station and/or c) an identity or characteristic of the provider of services accessible via the mobile station. For example, varying levels of security may be required by different users or by different telecommunications networks or by the providers of services or resources available using the mobile station. More specifically, a subscriber authorised for voice calls only, may, for example, only be required to undergo low-level authentication, whereas a subscriber authorised to access highly personal information via the mobile station, such as bank account information or geographic or positioning information, may be required to undergo high-level authentication.

The interacted sound signal 46, having been reflected in the soft tissues of the inner ear and auditory canal of the user, is then received by microphone 32 and converted into digital data by coder/decoder 16. The digital data output from coder/decoder 16 is then sent to the authenticating entity for analysis. Data representing the original sound signal 44 and the received interacted sound signal 46 are then compared to determine a signature corresponding to the physiological topology of the inner ear and auditory canal of the user. This may be performed using known techniques of digital audio signal processing such as using Fast Fourier Transforms (FFTs) to obtain a frequency response. The generated physiological signature is then compared to a pre-stored physiological signature or statistical model for the authorised subscriber to determine authenticity. If the determined signature matches within a predetermined level of tolerance, then the user of mobile station 10 is authenticated. However, if the determined signature does not match within the tolerance level, then the user of mobile station 10 is not authenticated. The process of determining the degree of match between the generated physiological signature and the pre-stored physiological signature uses known techniques of statistical pattern matching.

The pre-stored physiological signature or statistical model for the authorised subscriber of mobile station 10 may be determined in much the same manner as for subsequent determination of identity data according to the present invention. More specifically, on registration, the subscriber may be required to undergo a process to determine the physiological signature or statistical model to be stored and used for subsequent determination of identity data. By generating a plurality of test original sound signals and receiving the corresponding interacted signals a single average physiological signature or a more detailed statistical model indicating a normal range for the subscriber's physiological signature may be derived. Preferably, the test signals generated are sufficiently numerous so that an accurate average physiological signature or statistical model may be determined. Optionally, the test signals may comprise signals of different sound signatures corresponding to the different sound signatures that may be selected by the authenticating entity on subsequent determination of identity data.

Furthermore, because the topography of the inner ear and auditory canal may change gradually over time, especially with children and through ill health, the pre-stored signature or statistical model for a subscriber may be varied gradually over time in dependence on data determined during normal authentication procedures. For example, whilst a user presenting a radically different physiological topography will be rejected since the difference will exceed the predetermined level of tolerances a gradual and consistent change within the predetermined level of tolerance may be interpreted as a normal change in the topography of the inner ear and auditory canal, and the pre-stored signature or statistical model for that subscriber altered accordingly.

FIG. 4 is a schematic diagram showing the process of determining identity data for a user in a second mode where the mobile station generates the original sound. Mobile station 10 is the standard mobile station as described with reference to FIG. 1. The processes for determining identity data are as described above for the first mode where the mobile station generates the original sound, save that the interacted sound signal 48 is received by the standard microphone 20 located at the mouthpiece of mobile station 10 rather than by microphone 32 located at the earpiece. Thus, after loudspeaker 18 has generated an original sound signal 44, the interacted sound signal 48 is received by microphone 20 having traversed through the skull and soft tissues of the head of the user, and a signature is derived corresponding to the physiological topography of bone and soft tissues forming the user's head.

Optionally, sound signals transmitted from loudspeaker 18 to microphone 20 directly through the body of mobile station 10 may be cancelled from the received sound signal using signal processing techniques. For a given make and model of mobile station, the physical arrangement of components of the mobile station in normal operation is fixed. Thus, for a given original sound signal, a cancellation signal corresponding to the sound transmitted directly through the body of mobile station 10 may be determined and subtracted from the signal received by microphone 20. Thus a sound signal corresponding to the interaction of the original sound signal with substantially only the head of the user of mobile station 10 may be determined. In embodiments using hands-free equipment, the effect of sound transmission through the body of the mobile station is greatly reduced and cancellation may not be necessary.

FIG. 5 is a schematic diagram showing the process of determining identity data for a user in a third mode where the user generates the original sound. Mobile station 10 is an adapted mobile station as described with reference to FIG. 2. Whilst it has been described above how mobile station 10 may be used to generate the original sound for determining identity data for a user, in this alternate embodiment, the original sound signal is generated by the user of mobile station 10—i.e. the original sound is the voice or speech 50 of the user. This original sound signal is received directly by microphone 20, located at the mouthpiece, and indirectly, having traversed the head of the user, by microphone 32, located at the earpiece. From these two received signals, a signature corresponding to the physiological topography of the bone and soft tissue of the user's head may be determined and the determination of identity data carried out as described above. Preferably, the two received sound signals (from microphones 20 and 32) are processed to remove an information component in the signal but to retain a signature characteristic of the user. Thus, the actual voice, speech, or other utterance component of the signal is substantially cancelled leaving a signal corresponding to the physiological topography of the bone and soft tissue of the user's head. Note that any detectable sound from the user, such as the voice or speech, a hum, a mumble or even the user's breathing, should be sufficient to enable authentication to occur. Spoken words are not required.

When generating the pre-stored signature or statistical model for an authorised subscriber with embodiments using the third mode described above, rather than the mobile station generating a series of test sound signals, as described above, the user may be required to speak or voice other utterances into the mobile station. Optionally, the user may be required to recite a standard training passage of text of sufficient length and vocal variety to provide an accurate signature or model for the user. However, it is to be understood that by processing the two sound signals received during training, a user signature is derived which is independent of any words spoken.

Whilst preferred embodiments of the present invention using mobile stations of a mobile telecommunications network have been described above, it will be appreciated that the present invention has application to fixed or mobile telecommunications stations, for example telephone stations in networks such as the public switched telephone network (PSTN), fixed or mobile terminals or computing devices for access to private or public data networks, such as an intranet or the Internet, and in general to any electronic device where user authentication is needed, whether the device is capable of telecommunications or not. Furthermore, whilst it has been described that the physiological characteristics used for determining identity data are the topography of the inner ear and auditory canal, or the head of the user, it will be apparent that other physiological characteristics may be used, such as the topography of other parts of the body of the user or other physiological characteristics measurable using sound.

Other Embodiments of the Present Invention

According to a first alternate embodiment of the present invention, there is provided a method of determining identity data in respect of a user of an electronic device such as a telephony device, the method comprising the steps of:

a) receiving an interacted sound signal resulting from an original sound signal interacting with a part of the body of the user;

b) deriving a signature from at least the interacted sound signal, the signature being representative of a physiological characteristic of the user, the physiological characteristic not being a characteristic of the voice or speech of the user;

c) determining the identity data in dependence on the signature.

The interacted sound signals may be received more or less continuously and provide data from which a physiological characteristic of the user can be determined. Thus an enhanced, truly personal, and, if desired, continuous, user-based method of authentication is provided.

According to a preferred embodiment of present invention, the electronic device generates the original sound signal. Preferably, the original sound signal is undetectable or non-intrusive to the user. The sound signal may be outside the human auditory frequency range or, alternatively, inside the human auditory frequency range but of sufficiently short duration so as to be undetectable or unobtrusive. Thus, identity data may be determined by comparing an original sound signal, with known characteristics, to the received interacted sound signal, without disturbing the user.

According to another preferred embodiment of present invention, the original sound signal has a pre-selected characteristic, and the step of determining the identity data in dependence on the signature is dependent on the pre-selected characteristic. Thus, improved accuracy of authentication may be achieved by selecting a sound characteristic appropriate to the physiological characteristic being used for authentication.

Preferably, in a first determination of identity data, the original sound signal has a first pre-selected characteristic, and in a second determination of identity data, the original sound signal has a second pre-selected characteristic different to the first pre-selected characteristic. For example, the sound characteristic may be selected on a random or pseudo-random basis. Thus, security is generally improved against, for example, masquerade attacks by providing a varying “challenge” to the user.

Preferably, the pre-selected characteristic is selected by a process performed externally to the electronic device. Thus security is further improved against, for example, attacks in which the security processes of the electronic device have been determined by the attacker.

Preferably, the pre-selected characteristic is selected in dependence on a) an identity or characteristic of an authorised user of the electronic device; b) an identity or characteristic of an authorised user of a service accessible via the electronic device; and/or c) the identity or characteristic of a provider of a service accessible via the electronic device. Thus, a variable level of security may be selected appropriate to the particular circumstances of use.

In a further embodiment of the present invention, there is provided a method according to the first aspect, comprising the step of:

aa) receiving the original sound signal, wherein the original sound signal is produced by the user and the signature is derived from the interacted and original sound signals.

For example, the original sound signal may be the voice or speech of the user. Thus, authentication may take place using an original sound signal generated by the user without the need for the electronic device to generate sound signals for that purpose.

According to another preferred embodiment, the electronic device is a telephony device and comprises an earpiece for generating sound signals a mouthpiece for receiving sound signals and other sound signal processing apparatus. Thus, authentication of a user of the telephony device may be performed by receiving and/or processing sound or signals representing sound using apparatus present in the device for other purposes, thereby taking advantage of existing apparatus in the telephony device.

According to another preferred embodiment, the physiological characteristic relates to the physiology of the auditory apparatus or head of the user. Thus, advantage is taken of the unique topographies of the human ear or human head to perform accurate authentication.

The method of determining identity data may be carried out by a telecommunications network comprising an electronic device connectable to one or more network nodes, or by a stand-alone electronic device. The electronic device may be a telephony device such as a mobile station of a mobile telecommunications network.

According to a second alternate embodiment of the present invention, there is provided a telephony device arranged to process sound signals for use in determining identity data in respect of a user, the telephony device comprising audio signal coding/decoding apparatus arranged to use a first data coding format for coding or decoding the voice or speech of a user and a second different data coding format for coding or decoding sound signals for use in determining identity data of a user. Thus, the data coding format used may be optimised to the characteristics of the sound signals used when determining identity data in respect of a user.

According to a third alternate embodiment of the present invention, there is provided a telephony device comprising a locally accessible data store, the data store storing data representing one or more original sound signals, the telephony device being controllable by a remote device to generate a original sound signal using data stored in the data store and to receive an interacted sound signal resulting from the original sound signal interacting with a part of the body of a user for use in determining identity data in respect of the user. Thus, the quality of original sound signal generated may be guaranteed and network traffic reduced.

According to a fourth alternate embodiment of the present invention, there is provided a telephony device comprising a loudspeaker for generating an original sound signal and a microphone for receiving an interacted sound signal resulting from an original sound signal having interacted with a part of the body of a user of the telephony device, the telephony device being arranged so that, when in normal operation by a user, the loudspeaker and microphone are located adjacent to an ear of the user.

According to a fifth alternate embodiment of the present invention, there is provided an earpiece or headpiece for use with a telephony device, the earpiece or headpiece comprising a loudspeaker for generating an original sound signal and a microphone for receiving an interacted sound signal resulting from an original sound signal having interacted with a part of the body of a user of the telephony device, the earpiece or headpiece being arranged so that, when in normal operation by a user, the loudspeaker and microphone are located adjacent to an ear of the user.

1-24. (Cancelled)

25. A method of determining identity data in respect of a user of an electronic device, the method comprising the steps of:
a) the electronic device receiving a first sound signal produced by the user;
b) the electronic device receiving a second sound signal resulting from interaction of the first sound signal with a part of the body of the user;
c) the electronic device deriving a signature from at least the second sound signal in dependence on the first sound signal, the signature being characteristic of a topography of the part of the body of the user; and
d) determining identity data in dependence on the signature.

26. The method of claim 25, wherein the electronic device comprises a first sound signal receiver and a second sound signal receiver, the second sound signal receiver being located separate from the first sound signal receiver, the method comprising:
a) the electronic device receiving the first sound signal at the first sound signal receiver; and
b) the electronic device receiving the second sound signal at the second sound signal receiver.

27. The method of claim 26, wherein the electronic device comprises a mouthpiece, the first sound signal receiver being located at the mouthpiece.

28. The method of claim 26, wherein the electronic device comprises an earpiece, the second sound signal receiver being located at the earpiece.

29. The method of claim 25, wherein the electronic device is for accessing a telecommunications service, the method being performed during provision of the telecommunications service.

30. The method of claim 29, wherein the first sound signal comprises a voice signal.

31. The method of claim 25, wherein the step of deriving a signature comprises processing the first and second sound signals to remove an information component common to both of the signals, but to retain the signature.

32. A method of determining identity data in respect of a user of an electronic telecommunication device, the user having a human auditory system, the method comprising the steps of:
a) the electronic device producing a first sound signal during the provision of telecommunications services, the first sound signal being substantially undetectable by the human auditory system;
b) the electronic device receiving a second sound signal resulting from interaction of the first sound signal with a part of the body of the user;
c) deriving a signature from at least the second sound signal, the signature being characteristic of a topography of the part of the body of the user; and
d) determining identity data in dependence on the signature.

33. The method of claim 32, wherein the first sound signal is outside the human auditory system frequency range.

34. The method of claim 33, wherein the first sound signal is ultra-sonic.

35. The method of claim 32, wherein the first sound signal is within the human auditory frequency range but comprises one or more components of sufficiently short duration to be substantially undetectable by the human auditory system.

36. The method of claim 32, comprising:
conducting a first determination of identity data, in which the first sound signal has a first pre-selected characteristic; and
conducting a second determination of identity data, in which the first sound signal has a second pre-selected characteristic different to the first pre-selected characteristic,
the pre-selected characteristic being selected by a process performed externally to the electronic device.

37. The method of claim 36, wherein the pre-selected characteristic is selected in dependence on an identity or characteristic of an authorised user of the electronic device.

38. The method of claim 36, wherein the pre-selected characteristic is selected in dependence on the identity or characteristic of a provider of a service accessible via the electronic device.

39. The method of claim 32, wherein the electronic device is capable of telephony.

40. The method of claim 39, wherein the electronic device comprises an earpiece, the second sound signal being received at the earpiece.

41. The method of claim 39, wherein the electronic device comprises a mouthpiece, the second sound signal being received at the mouthpiece.

42. Apparatus for determining identity data in respect of a user of an electronic device, the apparatus comprising an electronic device arranged to:
a) receive a first sound signal produced by the user;
b) receive a second sound signal resulting from interaction of the first sound signal with a part of the body of the user; and
c) derive a signature from at least the second sound signal in dependence on the first sound signal, the signature being characteristic of a topography of the part of the body of the user,
wherein the apparatus is arranged to determine identity data in dependence on the signature.

43. Apparatus for determining identity data in respect of a user, the user having a human auditory system, the apparatus comprising an electronic telecommunication device arranged to:
a) produce a first sound signal during the provision of telecommunications services, the first sound signal being substantially undetectable by the human auditory system; and
b) receive a second sound signal resulting from interaction of the first sound signal with a part of the body of the user,
wherein the apparatus is arranged to derive a signature from at least the second sound signal, the signature being characteristic of a topography of the part of the body of the user, and to determine identity data in dependence on the signature.

44. A telecommunications network comprising apparatus according to claim 42, wherein the electronic device is connectable over a telecommunications link to one or more network nodes.

45. A telecommunications network comprising apparatus according to claim 43, wherein the electronic device is connectable over a telecommunications link to one or more network nodes.

46. The telecommunications network of claim 20, wherein one or more of the nodes is arranged to perform the steps of deriving a signature and determining identity data.

47. A telephony device comprising a locally accessible data store, the data store storing data representing one or more sound signals, the telephony device being controllable by a remote device to produce, during the provision of telecommunications services, a first sound signal using data stored in the data store and to receive a second sound signal resulting from interaction of the first sound signal with a part of the body of a user, the second sound signal being for use in determining identity data in respect of the user.

48. A telephony device comprising:
a loudspeaker for generating, during the provision of telecommunications services, a first sound signal; and
a microphone for receiving a second sound signal resulting from interaction of the first sound signal with a part of the head of a user of the telephony device,
the telephony device being arranged so that both the loudspeaker and microphone are locatable adjacent to an ear of the user.
